(19) United States
(12) Patent Application Publication
(10) Pub. No.: US 2008/0090269 A1
(43) Pub. Date: Apr. 17, 2008

(54) Compositions and methods for preparing specimens for microscopic analysis

(76) Inventor: Thomas M. Donndelinger, Nampa, ID (US)

Correspondence Address: KIRTON AND MCCONKIE, 60 EAST SOUTH TEMPLE,, SUITE 1800, SALT LAKE CITY, UT, 84111, US

(21) Appl. No.: 11/953,670

(22) Filed: Dec. 10, 2007

Related U.S. Application Data
(63) Continuation-in-part of application No. 11/400,468, filed on Apr. 7, 2006.
(60) Provisional application No. 60/670,119, filed on Apr. 11, 2005.

(51) Int. Cl. G01N 1/30

(52) U.S. Cl. 435/40.52

(57) ABSTRACT

Compositions and methods for preparing a biological specimen for microscopic analysis. Fixing compositions and dewatering compositions are provided with methods for their use that improve sample preparation and result in greater detail being available in the prepared specimen. Such compositions and methods also render more quantitative analysis of prepared specimens possible, and potentially enable a range of research and diagnostic tools.

### CROSS-REFERENCE TO RELATED APPLICATION

This application is a continuation-in-part of U.S. patent application Ser. No. 11/400,468, filed Apr. 7, 2006, which application claims the benefit of U.S. Provisional Patent Application 60/670,119, filed Apr. 11, 2005. These applications are incorporated herein by reference.

### BACKGROUND OF THE INVENTION

Methods of biological sample preparation for microscopic analysis were developed over one hundred years ago and continue to be used in research and industry with minimal change. These methods generally include steps of fixing a specimen, replacing the water in the specimen with a water-soluble substitute (often an alcohol), replacing the water-soluble substitute with a miscible solvent, replacing the miscible solvent with a solidifiable liquid, such as paraffin, and solidifying the sample for cutting and subsequent analysis.

In such methods, a sample is first exposed to a fixative agent to stabilize the cells present in the sample. Fixative solutions known in the art often precipitate or denature tissue enzymes to prevent autolysis, kill bacteria that could cause tissue decay, and render cellular constituents insoluble, thus preserving a biological sample and its constituents for study. Many suitable fixative preparations, such as aldehyde-based fixatives, are known to persons skilled in the art.

Proper selection and use of fixatives and fixation methods are important in preparing samples for microscopic analysis. This is especially the case when microscopy is performed to study cellular morphology or other microscale features of a cell or tissue. Those fixatives and specimen preparation methods known in the art generally provide an acceptable level of detail for observation at magnifications of up to about 200×, at which point detail begins to be lost.

One family of currently-used fixative compositions is aldehyde-based fixatives. This family includes, but is not limited to, formaldehyde (known as formalin when in a standardized solution of 37% to 40% by weight formaldehyde), glutaraldehyde, and paraformaldehyde. Formalin may contain 10% to 15% methyl alcohol to prevent polymerization of the formaldehyde. A common formaldehyde fixative media comprises 10% formalin. A 10% formalin composition contains 3.7% to about 4% by weight formaldehyde. These reagents are generally used as part of a fixative reagent “cocktail” that often includes buffers and other components. Phosphate buffers are commonly used in such preparations, but other suitable buffers are known to those of ordinary skill in the art.

In the tissue sample preparation methods discussed above, following the fixation step, a specimen must be further stabilized by removing and replacing the water it contains. To be effective, this “dewatering” step should not cause substantial damage or deformation to the structural components of the specimen. Historically, this dewatering step has involved exposing the specimen being prepared to a series of alcohol baths in which each bath has a diminishing concentration of water. The first bath often includes at least 20%, and as much as 30% by weight water. The final bath or series of baths is pure or “absolute” alcohol. Absolute alcohol is extremely hygroscopic, and is thus able to draw the last remaining water from the specimen. This generally includes water molecules closely associated with intracellular microtubular structures and intermediate filament structures, as well as water molecules stably incorporated into folded proteins. The water molecules associated with such structural elements of a cell are referred to herein as “structural water.”

The fixation and dewatering steps practiced in conventional sample preparation methods damage and distort specimens. The concentrated reagents used may cause proteins to denature, cause disruption of cytoskeletal features, and produce other artifacts. In addition, the removal of structural water from a specimen changes spatial relationships and conformations of cellular structures or components. The damage done diminishes the amount of detail perceptible beginning at magnifications of as little as 200× using light microscopy. The amount of damage done by traditional preparation methods acts as a complete barrier to the use of light microscopy at magnifications of 600× and higher. As a result, researchers are forced to turn to other microscopic techniques to view samples beginning at magnifications higher than 200× in order to view reliable detail.

It would be an improvement in the art to provide compositions and methods for preparing specimens for microscopic analysis which provide fixation and dewatering with reduced damage and distortion to the specimen. Such methods and compositions would allow samples to be analyzed at higher magnifications, resulting in improved ability to perceive detail in micrographs obtained from the samples, and as a result, improved research and increased data gathered.

Such methods and compositions are provided herein.

### BRIEF SUMMARY OF THE INVENTION

The present invention provides novel methods and compositions for preparing a specimen such as a biological specimen for microscopic examination. More specifically, the invention provides compositions and methods for fixing and dewatering a sample.

The present invention provides novel tissue fixative media and methods for fixing a specimen such as a cell or tissue sample for microscopic examination. These novel compositions and methods reduce damage and distortion of the specimen structure commonly caused by currently-known compositions and methods. The novel fixative media within the scope of the invention include fixatives known to those of ordinary skill and experience in the art. For example, the fixative media used in the methods of the invention may include aldehyde-based fixatives. Such aldehyde-based fixatives may be selected from the group consisting of: formaldehyde, glutaraldehyde, and paraformaldehyde.

In specific formulations of fixatives used in the methods of the invention, the fixative media may include an aldehyde-based fixative and have an osmolarity of between about 500 and about 1200 mosm/L. When formalin is selected for use in the fixative medium, formalin may comprise from about 4.5% to about 5% by weight of the fixative medium. In some preferred media, the fixative medium includes 4.7% by weight formalin. Variation within the provided range may be driven by the nature of the specimen being fixed. The aldehyde-based fixative may be selected from the group consisting of: formaldehyde, glutaraldehyde, and paraformaldehyde. The aldehyde-based fixative may be present in an amount from about 1% to about 2% by weight in the fixative medium. In one embodiment, the fixative medium may comprise from about 1.5% to about 2% by weight formaldehyde. Alternatively, the fixative medium may include from about 1.5% to about 2% by weight paraformaldehyde. Glutaraldehyde is an effective fixative, but its toxicity may limit the practical use thereof.

The fixatives of the invention may be unbuffered fixatives. Thus, in the methods and compositions of the invention, the fixatives used to fix and stabilize specimens of human origin or those originating from most major experimental animals do not require buffers. Buffers may be useful to some degree in highly bloody tissue samples or samples from certain organisms, such as flatworms to minimize formalin pigment formation.

The invention further provides methods of fixing and dewatering a specimen. According to the methods of the invention, a sample may be fixed by obtaining the specimen and exposing it to a fixative medium of the invention that incorporates a non-buffered fixative. This fixing step may be conducted for a prescribed period of time in order to assure appropriate fixation without allowing a sample to be damaged or begin to degrade. The biological specimen to be fixed is preferably exposed to the fixative medium for a period of time sufficient to provide adequate fixation. This time is dependent on the size of the sample being fixed. Those of ordinary skill in the art understand that diffusion of the fixative medium through a smaller sample occurs more rapidly than diffusion through a larger sample. As a result, fixation periods may range from as little as about ½ hour to at least about 1 hour. In others, as understood by one of ordinary skill in the art, a longer period of time may be necessary for a larger sample, and the specimen may be exposed for a period of time greater than an hour, occasionally requiring from about 6 hours to about 72 hours.

The dewatering methods of the present invention remove substantially all of the “free” water from a biological sample. Such free water is not associated with a protein or microtubular/filamentous structure in the cell or tissue like the “structural water” referred to above, and thus may be removed while preserving specimen structure. The methods of the invention preserve water molecules associated with proteins, microtubular/filamentous structures, and filamentous colloidal structures of the cytosol such as the actin filament-based colloids found in pseudopods. This helps to preserve structural relationships and the spacing of intracellular features. Allowing such structural water molecules to remain with the cell better preserves the native structure of the cell for observation. As briefly discussed above, currently-used dewatering methods strip substantially all of the water, free and structural, from the specimen being prepared, thus resulting in irreversible damage to the specimen and distortion of its features. Such damaged samples provide diminished detail when examined microscopically, and as a result, furnish less detail data to a researcher.

The dewatering methods of the invention retain water molecules associated with the structure of tissues, cells, intracellular structures, and proteins to preserve the specimen's structure and improve its ability to be accurately viewed by microscope. In the dewatering steps of the invention, a fixed specimen such as a cell or a tissue is obtained and exposed to a water replacement medium. The preferred water replacement medium includes an alcohol and a fractional amount of water. Unlike the dewatering methods currently used in the art, the dewatering medium of the methods taught herein always includes at least about 0.1% by weight water. Without being limited to any one theory, it is believed that the retention of the small fraction of water in the dewatering media of the invention allows the small fraction of water that is structurally important to a cell, protein, or other structure in a biological sample to remain. This preserves structures that are typically destroyed during conventional dewatering methods so that enhanced detail may be observed microscopically.

In the dewatering methods of the invention, the water replacement medium may comprise a variety of concentrations of an alcohol comprising at least 0.1% by weight water. In specific embodiments of the dewatering methods of the invention, the water replacement medium includes ethanol. The water replacement medium may include from about 0.05% to about 0.2% by weight water. In presently preferred water replacement media, the water replacement medium uses ethanol and about 0.1% by weight water. Because of the importance of knowing the water content of the alcohol, a high purity reagent grade alcohol may be preferred. Some lower grade alcohols may contain water in unknown or variable amounts.

As in the methods and media of the prior art, the step of removing water from a sample by exposing it to a water replacement medium may be repeated more than once, often using media that are increasingly “dry,” or having a diminishing percentage of water present. In the present methods, however, absolute alcohol is never used. Thus, the step of removing water from a sample by exposing it to a water replacement medium in the methods of the invention may be repeated using increasingly-concentrated alcohol media which always have from about 0.05% to about 0.2% by weight water. The dewatering methods of the invention may be utilized in currently-practiced methods of biological sample preparation in which a sample is obtained, fixed, dewatered, solidified, and sectioned (in some instances) or examined directly.

In the tissue-preparation methods of the invention, the sample may further be exposed to a space-replacement medium in the form of an alcohol miscible solvent to replace the alcohol used to displace and/or remove the water from the sample. Such alcohol-miscible solvents may include xylene, xylene substitutes or derivatives, or a mixture thereof.

The space-replacement medium is then replaced with a solidifiable material, such as melted paraffin. The paraffin is miscible in the xylene, and gradually displaces the xylene from the specimen. Following this, the specimen is allowed to harden. The hardened tissue specimen may then be sectioned. Sectioning is conducted using a microtome. The improved detail may be observed in samples prepared according to the methods of the present invention cut into sections having a thickness of from about 0.5 microns to about 5 microns.

In addition to the above, tissue sections that have been dewatered may be stained using techniques commonly known and used in the art. Common stains include hematoxylin stain and eosin stain. In some such staining techniques, the hematoxylin staining step is followed by a step of bluing the tissue section using a suitable agent such as ammonia. This step may be immediately followed by a step of washing the tissue section in tap water. The solidifiable material or paraffin is usually removed by mild heating and a series of xylene, alcohol, and water baths before it is stained.

The methods of the invention may be used to quantitatively judge the exactness of the detail obtained in a photomicrograph. Such methods may include the steps of obtaining a digital color photomicrograph of a stained sample using a light microscope at high magnifications ranging from about 600× to about 1000×; inverting the colors of the color digital micrograph; converting the color digital micrograph to grayscale; inverting the grayscale digital micrograph; and comparing the resulting photomicrograph with a corresponding electron micrograph.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a light micrograph of a specimen of a fruit fly leg illustrating a hair follicle and associated stretch receptor taken at 1000×;

FIG. 2 is a light micrograph of a specimen of tissue from a common house spider (species unknown), illustrating cells at prophase/metaphase taken at 800×;

FIG. 3 is a light micrograph of a paramecium illustrating detail obtainable in the macronucleus and micronucleus of the organism using the preparation methods of the present invention taken at 800×;

FIG. 4 is a light micrograph of a specimen of human skin tissue exhibiting incomplete and potentially differential viral infection taken at 800×;

FIG. 5 is a light micrograph of giant cells taken from human skin tissue illustrating potential differential nuclear staining, taken at 600×;

FIG. 6 is a light micrograph of human ova illustrating differential chromatin staining, taken at 800×;

FIG. 7 is a light micrograph of a cross section of human vas deferens smooth muscle cells showing actin-myosin fibers, taken at 800×;

FIG. 8 is an electron micrograph of “dark” and “light” human pancreatic acinar cells;

FIG. 9 is a light micrograph of a specimen of human pancreatic acinar cells prepared using the fixative compositions and methods of the present invention, taken at 800×;

FIG. 10 is an electron micrograph of stretched and contracted skeletal muscle tissue;

FIG. 11 is a light micrograph of a specimen of human skeletal muscle tissue prepared using the fixative compositions and methods of the present invention taken at 800×;

FIG. 12 is an electron micrograph of dark (D) and light (L) human cutaneous epithelial cells taken from a skin biopsy of a case of tuberous sclerosis; and

FIG. 13 is a light micrograph of a specimen of human cutaneous epithelial cells prepared using the fixative compositions and methods of the present invention.

### DETAILED DESCRIPTION OF THE INVENTION

The presently preferred embodiments of the present invention may be understood by reference to the following description and attached drawings. It will be appreciated that the components of the present invention, as generally described and illustrated in the figures herein, could be arranged and designed in a wide variety of different configurations. Thus, the following more detailed description of the embodiments of the compositions and methods for preparing specimens for microscopic analysis of the present invention is not intended to limit the scope of the invention, as claimed, but is merely representative of presently preferred embodiments of the invention.

### DEFINITIONS

As used herein, the term “biological specimen” is intended to encompass a wide variety of samples for microscopic analysis, including, but not limited to, single cells, clusters or groupings of cells, tissues, sections, or fragments thereof, organs or portions thereof, complete or partial organisms, or portions thereof, including, but not limited to, samples taken from animals, plants, fungi, multicellular organisms, and unicellular organisms.

The term “fixation” describes a first step in processes for preserving specimens for microscopic examination in which the cells of the specimen are killed and the specimen is protected from subsequent decay. Fixation is generally accomplished by applying a fixative medium to the biological sample and allowing the medium to remain in contact with the sample for a sufficient period of time to affect each cell of the sample. Such fixatives act to precipitate, denature, or otherwise render the enzymes in the sample inoperative to prevent autolysis, kill any bacteria present to prevent degradation, and render many of the constituents of a cell of the sample insoluble. Many fixative media are known and used in the art, and may be used within the scope of the invention. In presently preferred embodiments of the instant invention, aldehyde-based fixatives such as formaldehyde, glutaraldehyde, and paraformaldehyde are preferred fixatives.

“Osmolarity” is a term known and used in the art to describe the concentration of a solution measured in terms of the number of moles of ions in solution and is generally expressed in terms of milliosmoles per liter. It thus serves as a measure of the osmotic pressure, or the pressure associated with osmosis produced by the molar concentration, of a solution.

In the present application, the term “water replacement medium” is used to denote a water-soluble medium such as an alcohol applied to a biological specimen, generally in a concentrated form, which displaces the water in a specimen by a process such as osmosis or diffusion to allow stabilization of the specimen. In methods of specimen preparation known in the art, a specimen is initially exposed to water replacement media containing a considerable water component, often in the range of 20-30% by weight. This amount is then gradually decreased in a series of subsequent baths to which the specimen is exposed to gradually remove substantially all of the water from the specimen. To accomplish this, the specimen is exposed to at least one bath with a water replacement medium containing essentially no water, such as absolute alcohol. In common use, the alcohol used in water replacement media is often ethanol, although other suitable agents are known to one of ordinary skill in the art and encompassed within the scope of this term.

The water replacement media used in the method of the invention always include a small percentage of water greater than or equal to about 0.05% by weight. Some appropriate media may include from about 0.05% to about 0.2% water by weight. Some specific media include about 0.1% water by weight. Determining a suitable concentration within this range may be made based on factors including the amount of water already present in a specimen. Success of a particular concentration used on a particular specimen may be judged by comparing the structure obtained with a reference such as an electron micrograph.

As used herein, the term “free water” denotes water molecules unassociated with structures of a protein, an intracellular structure, a cellular structure, an extracellular structure, or of a tissue. Free water may be removed from a specimen without having a substantial adverse effect on the size, shape, or appearance of a protein, structure, organelle, cell, or tissue. This term is intended to be used as an approximate opposite of the term “structural water” discussed in greater detail below.

The term “structural water” is used herein to denote water molecules that are closely associated with a protein, an intracellular structure, a cellular structure, an extracellular structure, or a tissue. Such water molecules may generally not be removed from a specimen without adversely affecting the size, shape, or appearance of a protein, structure, organelle, cell, or tissue of the sample being prepared. In some instances, structural water includes, but is not limited to, water molecules present in folded protein molecules and other water molecules held within a three-dimensional structure, water molecules associated with intracellular microtubular structures, water molecules associated with intermediate filament structures, filamentous colloid structures of the cytosol, and other protein or carbohydrate-associated water molecules. Other structural water molecules known to those of ordinary skill in the art are included within the scope of this definition.

In the present application, the term “space replacement medium” denotes a substance miscible or soluble in the water replacement medium that is used to replace the water present in a biological sample. Suitable space replacement media include xylene and xylene substitutes. Some xylene substitutes are sold under trade names including, but not limited to, PRO-PAR, from Anatech, Ltd., of Battle Creek, Mich.; Clear-Rite 3, from Richard-Allan Scientific of Kalamazoo, Mich.; and Shandon Xylene Substitute of Thermo Electron Corporation (worldwide). Other isoparaffinic aliphatic hydrocarbons may also be used as xylene substitutes. One of skill in the art understands the risks and beneficial properties of xylene and knows the relative drawbacks of some of its substitutes and will be able to select proper space replacement media within the scope of the invention.

It is also desirable that the space replacement medium be soluble in a stabilizing medium which replaces the space replacement medium in a subsequent step of the methods of the invention. In many instances, the stabilizing medium used is a melted paraffin wax that is capable of dissolving in the space replacement medium and gradually replacing it as in the water-replacement step of the methods of the invention. Once the stabilizing medium has displaced the water replacement media from the specimen, it may be solidified to allow further processing (such as sectioning) of the sample or its storage. It may be desirable for the stabilizing medium to be solid at room temperature and to have a melting point not too far above room temperature. Paraffin is a common stabilizing medium. Commercially available paraffin is graded by physical characteristics such as hardness and melting point. Harder grades of commonly-available embedding paraffin may be used in the invention to facilitate sectioning at 1 micron. Such grades of paraffin generally have a melting point of from about 55° to about 57° C. In some instances, Type 9 Paraffin available from Richard-Allan Scientific of Kalamazoo, Mich. may be used in the methods of the invention.

The term “stain” is used herein to describe a family of dyes, pigments, or other indicator compounds used to provide contrast or visibility to otherwise transparent portions of a specimen. Some such agents may also be used to label individual portions or components of a specimen. A large variety of such stains is known and used by those of skill in the art of microscopic sample preparation, each of which may be included within the scope of the invention. In some presently-preferred methods of the invention, hematoxylin and eosin stains are used. Antibody stains known and used in the art are also suitable in the methods of the invention, and expressly included within this definition.

Thus, the present invention provides novel fixative and dewatering compositions and tissue preparation methods using these compositions. The novel compositions of the invention will be discussed below, following which the novel fixation and dewatering methods will be presented.

The invention first provides novel tissue fixative media for improving the detail available in a prepared sample. These fixative media generally include an unbuffered aldehyde-based fixative medium with an osmolarity of from about 500 to about 1,200 mosm/L. Some fixatives of the invention have an osmolarity of about 1000 mosm/L. In these fixative media, the aldehyde-based fixative may preferably be formaldehyde, glutaraldehyde, paraformaldehyde, or a mixture thereof. Although the selected fixative media may be present in concentrations of from about 1% to about 2.5% by weight, individual fixative preparations may have from about 1.5% to about 2% by weight of the aldehyde-based fixative. In one presently-preferred embodiment, the fixative medium includes about 1.6% to 1.8% by weight formaldehyde. In another, the fixative medium may include from about 1.5% to about 2% by weight paraformaldehyde.

The fixative media of the present invention may further include a divalent cation, such as zinc. One specific fixative medium according to the present invention is an unbuffered 5% zinc formalin solution. These zinc cations may be provided as zinc sulfate. Other divalent group 12 cations such as mercury and ytterbium could potentially serve the same purpose. The zinc cations used in the compositions of the invention appear to act to further preserve chromatin detail to allow direct comparison of images of fixed samples with electron micrographs.

In preparing the fixative media of the invention, the osmolarity of the fixative medium is preferably controlled. Buffered 10% formalin fixatives currently known and used in the art often have an osmolarity of around 2,000 mosm/L. Without being limited to any one theory, it is thought that this level of osmolarity causes dehydration and shrinkage of the tissue sample being prepared. It has been discovered that a useable range for formalin is from about 4% to about 6% by weight with an osmolarity of from about 500 to about 1,200 mosm/L, and is in some cases preferred at about 1,000 mosm/L. This limits the amount of shrinkage due to water extraction by osmosis.

Formalin has historically been produced by adding 6-15% solution of methanol to a saturated formaldehyde solution. The methanol has been used to interfere with the polymerization of the formaldehyde to increase the fraction of free formaldehyde and slow polymerization. Methanol may be optionally added to the fixative compositions of the invention to serve a similar function. In the methods of the present invention, however, a much smaller fraction of methanol is added. This helps reduce the osmolarity of the solution. Thus a small amount of methanol may be added to compositions according to the present method to improve formaldehyde availability. In some methods of the present invention, the methanol may be provided as a solution having from about 0.1% to about 0.5% concentration. In specific fixative compositions, 0.1% methanol is used.

It has also been discovered that the use of buffers such as phosphate buffers in fixative media denatures proteins. This denaturing event generally results in the proteins at least partially unfolding and refolding in phosphate space or water space. This may completely alter the characteristics of the proteins, as well as their structures, as is observable in the stabilized sample. Further, epitopes of antigens are often altered and even hidden by the process. Many methods of “antigen retrieval” are often practiced in the art to overcome this. These retrieval methods often require a sample to be exposed to high heat, microwaves, boiling, steaming, etc. Such methods are extremely destructive to the sample being prepared. This may cause cellular detail to be scrambled or otherwise lost and the observable resolution of the sample to be limited. The methods of the present invention often eliminate the need for such antigen retrieval steps.

Phosphate buffers are preferably eliminated in the fixative media of the invention. However, small amounts of phosphate buffers may be added to the fixative media of the invention for use with bloody tissue specimens in order to eliminate what is referred to as “formalin pigment” found in such samples prepared without phosphate buffers. Formalin pigment is believed to result from formaldehyde complexing with hemoglobin. Some organisms or tissues may benefit from the use of a phosphate buffer to control formalin pigment and/or to provide phosphorus to facilitate proper protein folding.

Using the fixative media of the invention, the time needed for proper fixation is related to the size of the tissue sample being fixed. As known to one of ordinary skill in the art, diffusion rates are generally taken to be about 0.1 mm per hour. Fixative exposure times are calculated accordingly. Unless tissues are minced to a size less of than 1 mm thick, fixation may be a slow process. The length of the process, if significant, may allow cellular proteins like microtubules to disassemble. Sample and/or reagent heating may be used to accelerate the chemical reactions that occur during fixation, but heated samples or reagents should generally not exceed 105 degrees Fahrenheit. Beyond 105 degrees Fahrenheit, heat shock proteins must often be added for corrective refolding of proteins. This is generally impossible in the preparation of non-living tissue specimens, however.

Without being limited to any one theory, it is thought that the use of aldehyde-based fixatives produces methylene bridges between residues. This is believed to result from the presence of a limited concentration of formaldehyde that exists in the fixative along with a more predominant polymerized fraction.

In some methods of the invention, fixation may continue during additional processing steps using formaldehyde or other fixatives such as PenFix (10% by weight neutral buffered formalin in a 70% by weight alcohol mixture of ethanol, methanol, isopropanol, and hexone) commercially available from Richard-Allen Scientific. This may be used to provide better detail of glycoprotein structures. It has been demonstrated that formaldehyde actually does fix proteins and nucleic acids, especially RNA, by rendering them adherent to each other in three-dimensional space so that there is limited migration in two-dimension gel electrophoresis. Using other fixatives besides formaldehyde may severely compromise the detail on reference checking comparisons with electron microscopic images (including published images or images of samples analyzed in parallel).

Fixation of samples using conventional formalin concentrations greater than about 5% by weight will introduce distortions. Use of formalin at even higher concentrations results in shrinkage with recoil back to normal dimensions that may occur over a period of about two weeks following initial sample fixation as a result of the reversibility of the bonds and the reintroduction of water into the tissue. In addition, protein refolding and loss of detail will be present due to the physical chemical alteration of proteins and cellular components by the high osmotic pressure of formalin greater than 5% by weight. Further, the presence of phosphate buffers in conventional fixative compositions will irreparably alter the detail, as seen when a specimen prepared with such compositions is compared with an electron microscopic frame of reference. In one embodiment within the scope of the invention, the formalin concentration is less than 5% by weight.

The invention further provides compositions and methods for dewatering a fixed sample for microscopic examination. The dewatering steps taught in the present invention include exposing a biological sample to a water replacement medium comprising an alcohol and from about 0.05% to about 0.2% by weight water. In specific embodiments, the water-replacement medium includes about 0.1% by weight water. This step may be conducted as a series of related steps in which the sample is exposed to increasingly concentrated alcohol, beginning with a bath having at least as much as 20% by weight water, for example, and proceeding with successive baths having concentrations of water never becoming lower than about 0.05% by weight. As noted above, common methods known in the art teach dewatering using at least one final step in which the sample is exposed to absolute alcohol. The methods of the invention specifically teach that absolute alcohol may not be used unless diluted with water to have from about 0.05% to about 0.2% by weight water. Without being limited to any one theory, it is believed that exposure of a tissue sample to absolute alcohol strips structural water away from cellular structures such as microtubules, secondary filaments, and folded proteins, destroying or altering structure and decreasing the amount of detail discernable in the sample. It is believed that the dewatering step of the present invention allows a larger proportion of such structural water molecules to remain in place, thus better protecting the structure of the sample.

The removal of all water molecules will affect the protein folding structure and interaction between proteins, as well as the spatial dimensions and view of filamentous colloid structures of the cytosol since there is a minimum amount of water required to maintain the folded structure of a protein and the spacing present in such colloidal structures. Water molecules interact with proteins and other cellular structures in a variety of ways. Such interactions also include electrostatic, Vanderwalls or short-term polarization interactions of water molecules with proteins or cellular structures. The polarization of water molecules adjacent to proteins allows the formation of gel structures. Destruction of these gel structures by the removal of water irreversibly alters protein and cellular matrix structures. Other relationships with water molecules of a nonpolar enthalpic and entropic nature are important for maintaining protein and matrix structures. For this reason, the alcohol dehydration steps must not be taken to full completion. Absolute alcohol is a severely hygroscopic agent that will remove water molecules that are required for preservation of gel-like structures as well as folded protein structures. Hence, a small residue of water must be maintained within the alcohol to preserve the cell structures and protein structures.

In some embodiments, the dewatering steps are performed using a water replacement medium including ethanol and no less than 0.1% by weight water. Other suitable alcohols are known to those of ordinary skill in the art. In some water replacement media used in this step, the water may be present at concentrations of from about 0.05% to about 0.2% by weight. In others, water is present at about 0.1% by weight. Further, in some methods, these dewatering steps may be repeated to achieve better removal of water from a sample.

Alcohol is used as a dehydrating agent to allow the dehydrated sample to eventually be embedded in a stabilizing medium such as paraffin after replacement of water molecules. Specifically, xylene or other solvents miscible with liquefied paraffin are applied in steps such that the alcohol is removed and replaced by a miscible solvent such as xylene or a related compound. The elimination of alcohol will then allow space replacement by liquid paraffin in subsequent replacement steps through multiple exchanges of xylene. Reasonable nondeforming water will be removed from the specimen, but sufficient residual water molecules are retained to maintain the protein and matrix structure.

The tissue is infiltrated with paraffin, then embedded in paraffin blocks (or blocks of other stabilizing media) and sliced on a microtome. The microtome is adjusted to slice sections at a desired thickness. For some studies directed to small intracellular features, it may be desirable to produce sections having a thickness in the range of from about 0.5 to about 1.5 microns. The small section thickness is necessary to prevent overlay of cytoplasmic and nuclear details. Such overlay may obscure the dimorphic appearance of chromatin after eukaryotic cell division, for example. In other studies, it will be desirable to observe sections having a thickness of greater than 1.5 microns up to about 5 microns. Following sectioning, tissue sections are then deparaffinized with heat, subjected to a series of xylene, alcohol, and water baths, and stained using hematoxylin and eosin as taught in the art. The staining procedures used in the art must be adapted to allow for the preservation of necessary water molecules to maintain detail, however.

The residual paraffin is removed by heating and xylene baths followed by exposure to alcohol having a concentration of from about 0.05% to about 0.2% by weight water. After removal of xylene with subsequent decreasing concentrations of alcohol baths, hematoxylin stain or other suitable stain is applied, followed by a step of bluing with ammonia or other effective chemicals. After washing steps, the eosin stain is applied followed by washing bath steps. Subsequent steps use alcohol to remove residual water, again allowing for from about 0.05% to about 0.2% by weight water in the absolute alcohol baths that are used. Because the coverslip mounting media is not miscible with alcohol, slides are washed in xylene, then coverslip mounting media is applied and slides are observed.

The use of immunoperoxidase to identify antigens using specific antibodies can be performed on unstained tissue slices at 0.5-1.5 microns. Because the present invention better preserves antigens in the sample, the antibody may need to be diluted further than normally recommended for traditionally fixed tissues. As a result, less antibody may be required in the methods of the invention when compared to methods currently used to prepare similar specimens. Unusual and destructive “antigen retrieval” treatments utilizing steam, pressure-cooking, microwaves, or heat may be unnecessary due to the better preservation of antigens by the tissue processing methods of the invention. Usual histological stains may be applied.

The coverslipping medium that is used, depending on the variety, may be subjected to polymerization. Due to the different monomer-oligomer configurations available for mounting media, the slides must be observed for creep. Creep is defined as associated structural drag or copolymerization of tissue sections with the mounting media. Tissue creep due to incompatibilities of different mounting media may adversely affect or destroy the high-resolution detail available over periods of time as little as a few hours. More specifically, detail is lost as the coverslipping medium polymerizes, attaching itself to structures/features of the specimen and moving or deforming them as the polymers extend and migrate. The effects of tissue creep may be reduced/prevented by the careful selection of the mounting medium used.

The invention further provides methods of preparing a tissue sample for microscopic examination using the fixative and/or dewatering compositions of the invention. Such methods include the steps of obtaining/providing a tissue sample desired to be examined and fixing the tissue sample by exposing it to a fixative solution such as those described above for a sufficient period of time. These methods may additionally include the novel dewatering steps described above to remove water from the sample.

The invention also enables more quantitative methods for measuring the quality or amount of detail in a prepared sample. In classical tissue fixation, arbitrary judgments are made to assess the exactness and amount of detail present in a prepared sample. Ultrastructural detail is obtained in electron microscopy with rapid fixation. The interpretation of artifacts has been judged based upon over 50 years of experience in order to reach a consensus about acceptable standards in electron microscopy.

The methods of the invention provide a more quantitative frame of reference for assessing the quality of a light micrograph by allowing direct comparison to electron micrographs. Specifically, the detail and quality of a tissue sample prepared according to the present invention may be assessed by comparing an image obtained at high resolution (about 600× to 1,000×) with a light microscope with those obtained with an electron microscope. This assessment is made using digitally-captured images of hematoxylin- and eosin-stained specimens prepared using the compositions and methods taught herein. In order to render the detail of the images more apparent, the color scale of the images may be altered. More specifically, in some situations it may be advantageous to gray-scale and/or color invert the images. In some instances, gray-scaling the images may render their appearance similar enough to the usual appearance of an electron micrograph at comparable magnification to permit direct comparison of the light-micrograph and the electron micrograph. Detail should be similar when micrographs from light and electron microscopes are compared, taking into consideration the limitations of the light microscope at 200 nanometers of resolution.

The finished slide is examined with a light microscope. The specimen is observed at about 600× to 1,000× with oil immersion, preferably including condenser. High-resolution digital images may be taken of the slide. These images may then be subjected to gray scaling and inversion. The detail is, at this point, compared with published electron micrographs of the same tissue for electron micrographs of parallel specimens. Such comparisons are possible using the micrographs presented in Examples 7 and 8, 9 and 10, and 11 and 12, which follow.

The compositions and methods provided by the present invention may inspire changes in many related compositions and methods used in the field of tissue preparation/sample preparation and examination. Specific alterations may include changes to compositions that contact a specimen prior to its observation under a microscope to include a fraction of water as taught herein to preserve the structural water found in the sample. Methods may be adjusted to assure the preservation of such structural water. In addition, many research and diagnostic methods may be revised and/or expanded to exploit the greater amount of detail available in specimens prepared using the compositions and methods of the present invention. Further, in research using reagents to identify a structure or chemical by staining, the levels of reagent (such as antibodies) must generally be reduced such that a more diluted tag is used. Otherwise, usual histologic stains may be applied to a sample prepared using the compositions or methods taught herein.

### EXAMPLES

The Figures provided with the present invention include images obtained from specimens prepared using fixation methods and compositions within the scope of the present invention. In some cases, images obtained from specimens prepared within the scope of the invention are compared with electron micrograph images.

Each of the specimens examined in the following examples was prepared using similar fixative media according to the present invention. More specifically, each of the fixative media used included 5% unbuffered zinc formalin. The zinc was provided in the form of zinc sulfate. Without being limited to any one theory, it is thought that the zinc is necessary to maintain accurate chromatin detail. Specimens prepared using a fixative medium according to the present invention including zinc cations were found to be more comparable to electron micrographs than specimens prepared without zinc.

### Example 1

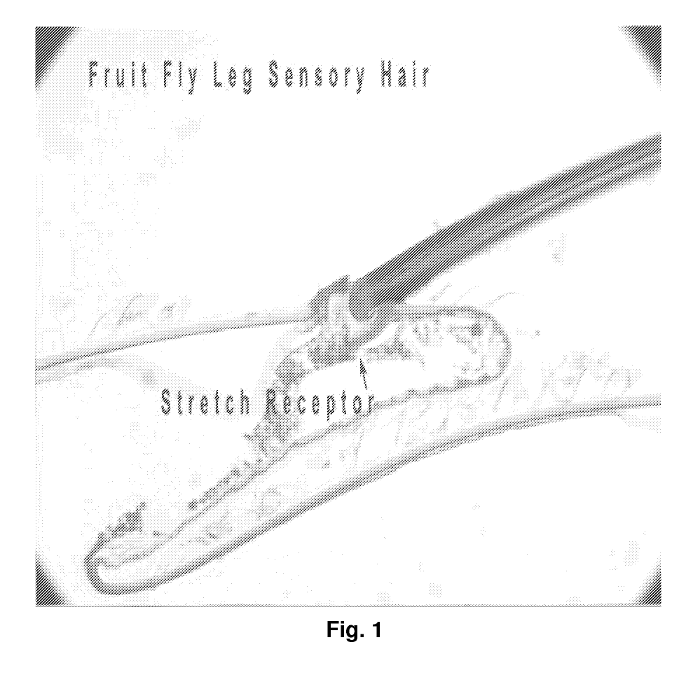

In a first example, an image of a specimen taken from the leg of a fruit fly illustrating a hair follicle and attached stretch receptor is shown in FIG. 1. This specimen was prepared using a fixative composition of the invention having 5% unbuffered formalin. Following this initial fixation step, the specimen may be exposed to PenFix™ to further stabilize it. The PenFix™ may be omitted in some variations of the methods of the invention. Rapid initial fixation using unbuffered fixatives of the invention with controlled osmolarities allows early crosslinking to happen without removal of structural water molecules. Use of buffers subsequent to this initial fixation step is thought to be less harmful to structure and observable detail after this initial fixation step.

The formalin used in this step was a 5% unbuffered zinc formalin solution as described above. The secondary fixative used in some embodiments of the present invention is marketed under the name PenFix™ and is distributed by Richard-Allan Scientific. PenFix™ has ingredients including formaldehyde, ethyl alcohol, isopropyl alcohol, methyl alcohol, methyl isobutyl ketone, and a proprietary buffer. The specimen was placed in a Tissue-Tek®VIP™ tissue processor distributed by Sakura®. The specimen remained in the processor for a period of two hours and 45 minutes. The specimen was exposed to the formalin solution described above for the first two hours and then to PenFix™ for the final 45 minutes. Following this, the water was removed from the sample using graded alcohol baths starting with a concentration of approximately 80% alcohol and gradually increasing in concentration until the specimen is exposed to concentrated alcohol having from about 0.05% to about 0.2% by weight water.

Following this, the alcohol was removed from the specimen by processing using xylene, and was then subsequently embedded in type-9 paraffin from Richard-Allan. Following the step of embedding the samples in paraffin, the blocks of paraffin enclosing the specimens were cooled on an ice plate. The specimen was then cut into slices approximately 1 micron thick. The resulting individual slices were deparaffinized by heating and using xylene to displace residual paraffin. The tissue sections were then stained using eosin and hematoxylin. Following this step, the sections were mounted to slides and coverslipped using Micromount® coverslipping medium from Surgipath®, including methyl methacrylate, xylene, dibutyl phthalate, and BHT. This image was obtained at a magnification of 800×.

The amount of detail available in this specimen is remarkable in that it retains the structure of the chitinous exoskeleton of the insect while illustrating the morphology of the hair follicle including the stretch receptor attached to the hair. Such detail not only provides insight into the anatomy of the species, but this technique may be utilized to study additional specimens to better characterize the embryonic origin of such features.

### Example 2

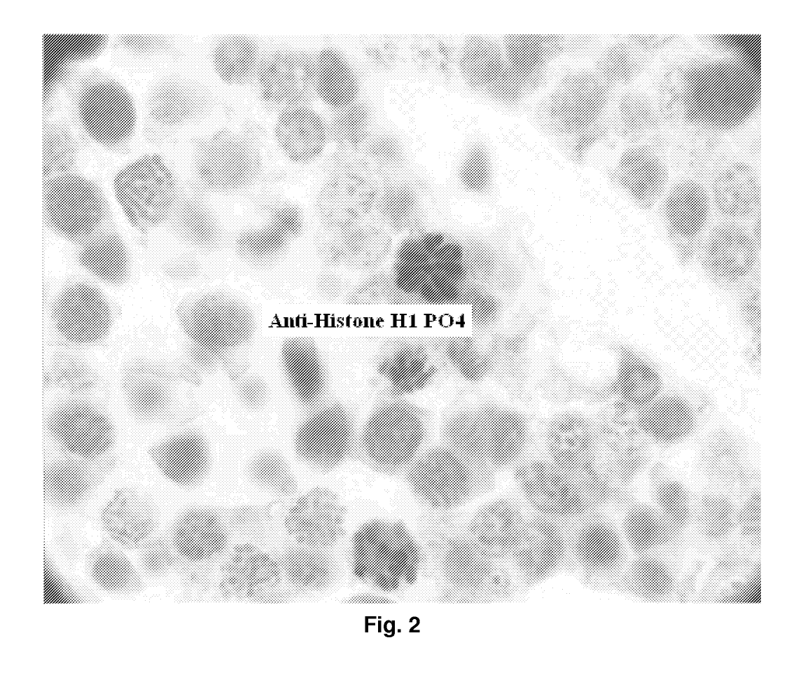

In a second example, FIG. 2 is a micrograph of tissue taken from a common household spider of unknown species showing cells in prophase/metaphase, fixed using methods of the invention. The fixative medium used included 5% unbuffered zinc formalin. This specimen was prepared using methods and compositions substantially in accordance with the method of Example 1. This specimen was prepared using an anti-histone H1 PO₄ antibody and an immune peroxidase stain. Without being limited to any one theory, it is believed that this micrograph (taken at 800×) illustrates differential staining of phosphorylated histone H1 in these dividing cells.

### Example 3

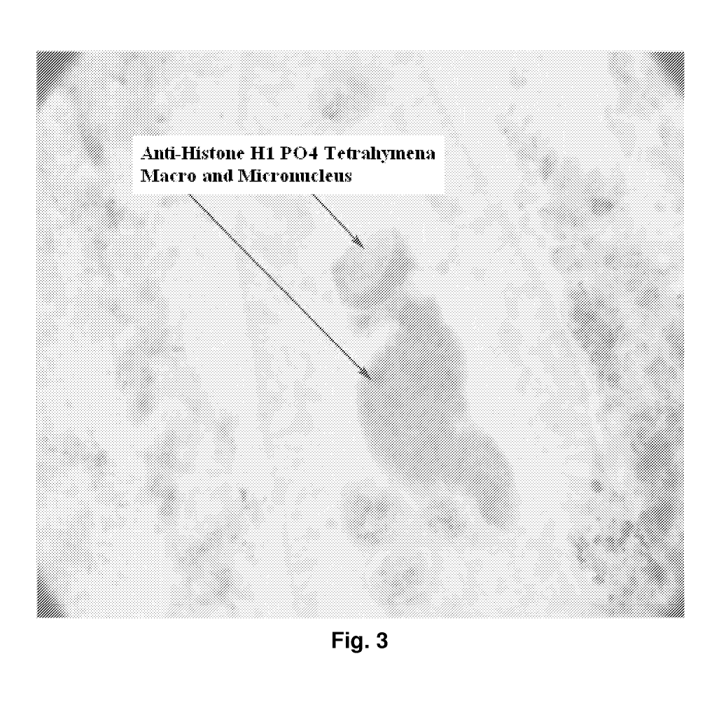

Example 3 illustrates the fixation of a single-celled organism using the methods of the invention. More specifically, a micrograph (taken at 800×) is provided in FIG. 3 of a paramecium fixed using the methods of the present invention. As in Example 2 discussed above, the specimen was fixed using the 5% unbuffered zinc formalin fixative medium of the invention and exposed to an anti-histone H1 PO₄ immune peroxidase stain. Differential staining is observed in the nucleus and micronucleous of the organism.

### Example 4

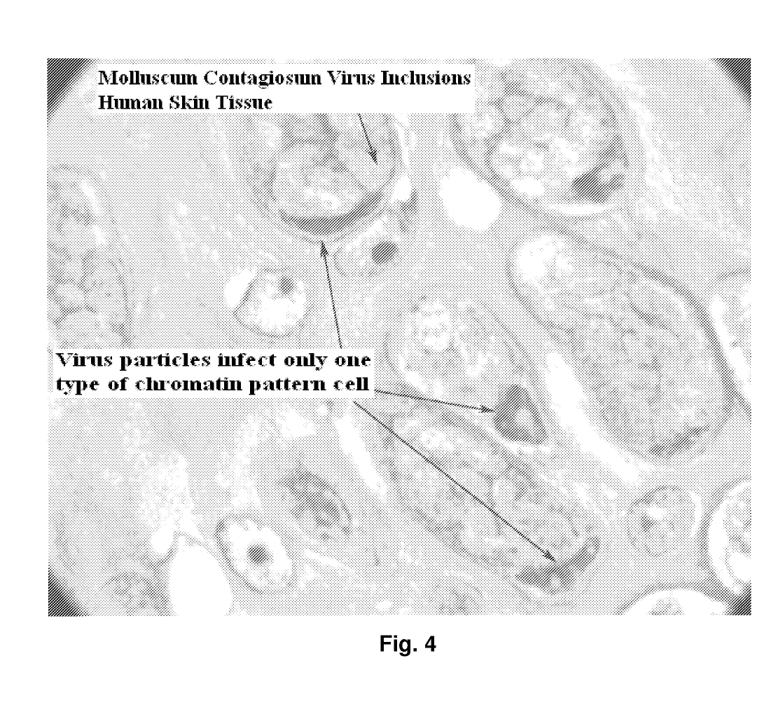

In Example 4, a specimen of human skin tissue was prepared using the 5% unbuffered zinc formalin fixative medium according to the present invention. The fixed specimen was stained using hematoxylin and eosin stains. The resulting image (taken at 800×) is included herewith as FIG. 4. The stained specimen illustrates differential infection of cells by a virus, Molluscum Contagiosum, as seen by the presence of viral inclusions in cells having a first pattern of chromatin staining and not in cells having different chromatin staining patterns.

### Example 5

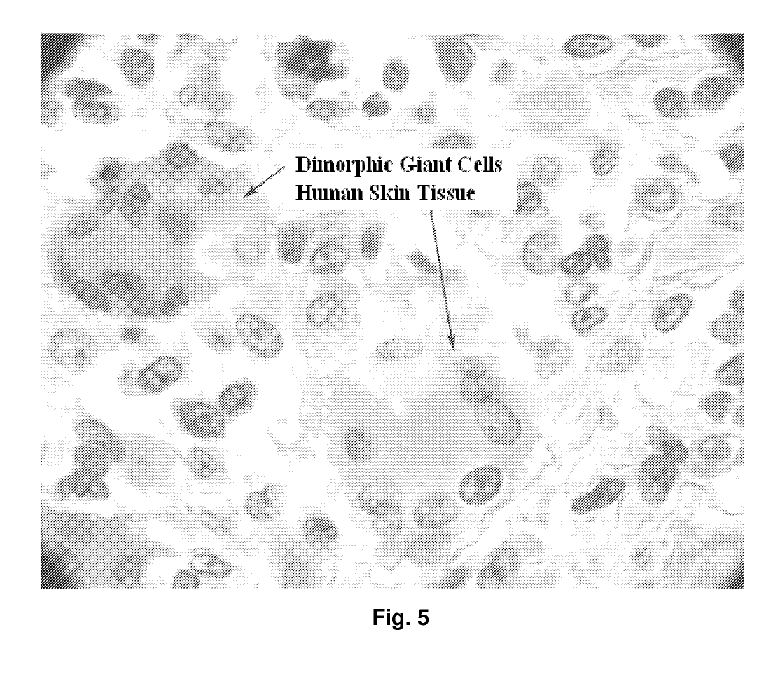

In Example 5, a specimen of human skin tissue was prepared using the fixative medium and stained, as above, with hematoxylin and eosin stain. The micrograph provided of the specimen in FIG. 5 (taken at 600×) shows a pair of dimorphic and differentially-stained giant cells.

### Example 6

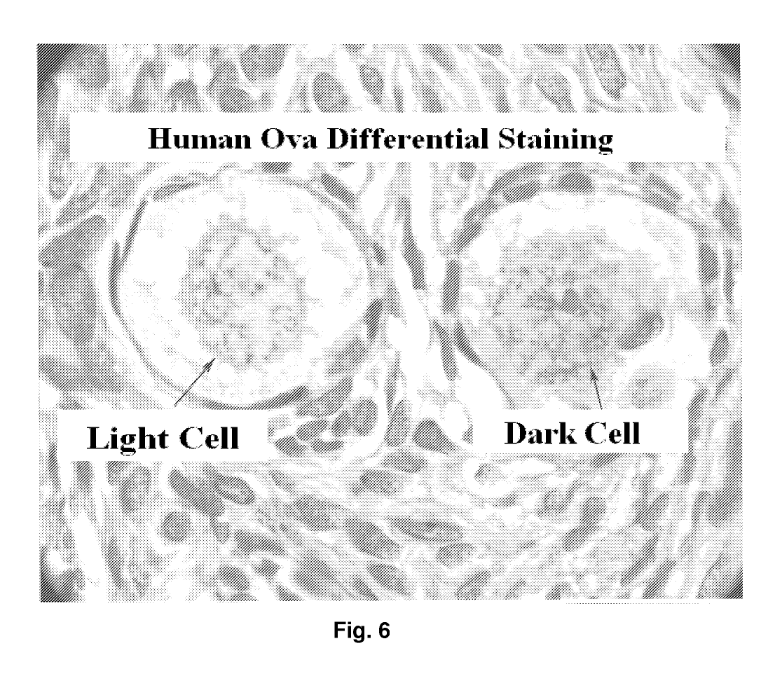

In this example, a specimen of ovarian tissue was prepared using the methods of the invention discussed above using 5% unbuffered zinc formalin in the form of zinc sulfate and stained using hematoxylin and eosin staining. The specimen is shown in FIG. 6, with the image having been taken at 800×. FIG. 6 shows two human ova illustrating differential chromatin staining. The ovum on the left illustrates lighter chromatin staining, and may thus be referred to as a “light cell,” while the ovum on the right illustrates darker chromatin staining and may thus be referred to as a “dark cell.”

### Example 7

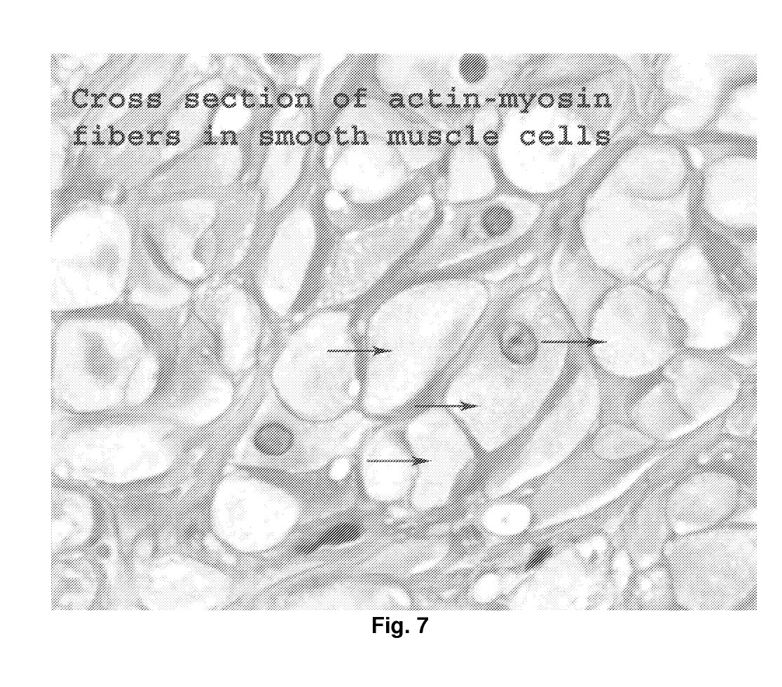

FIG. 7 is a light micrograph of human vas deferens tissue providing a cross-sectional view of the actin-myosin fibers of smooth muscle cells of the vas deferens. This specimen was prepared substantially as in the previous examples. The arrows provided in FIG. 7 designate individual actin-myosin fibers viewed in cross-section. The spacing of the fibers appears to have been preserved. The specimen was taken from vas deferens tissue and prepared according to the methods of the invention, stained with hematoxylin and eosin, and viewed at 800×.

### Example 8

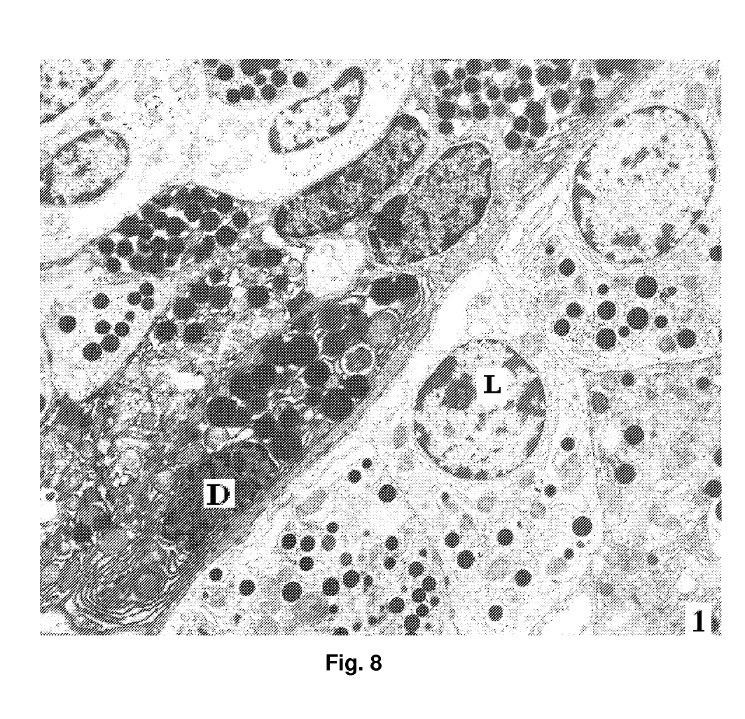

FIG. 8 is an electron micrograph of “dark” and “light” human pancreatic acinar cells. This specimen was taken from a portion of the body of the pancreas resected with an insulinoma. As such, this image represents the accepted standard of the detail available using extremely high magnification imaging. FIG. 8 was taken from Ultrastructural Pathology of the Cell and Matrix: A Text and Atlas of Physiological and Pathological Alterations in the Fine Structure of Cellular and Extracellular Components, Ghadially, Feroze N., 3d Ed., Vol. 2, Butterworths: Boston, pp. 842-843, 954-957.

### Example 9

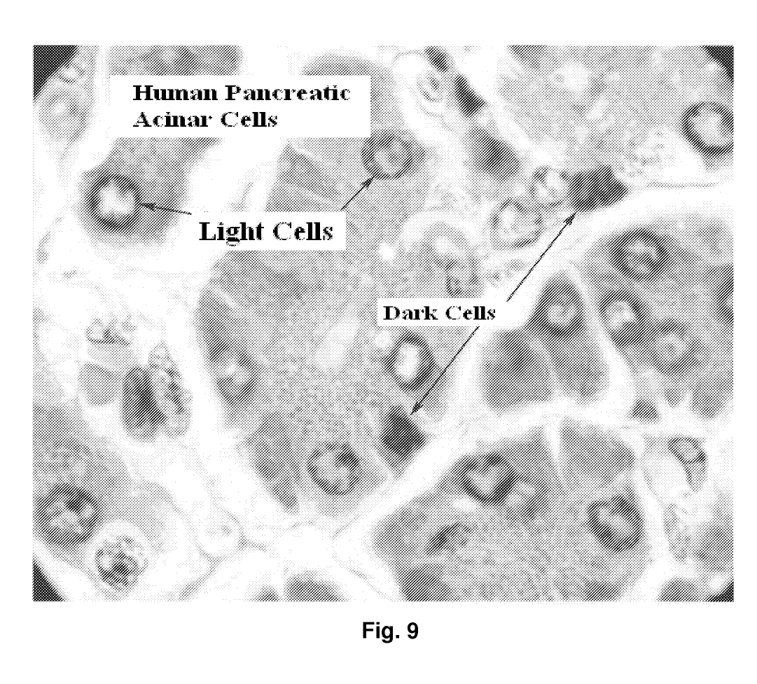

FIG. 9 is a light micrograph of a specimen of human pancreatic acinar cells prepared using the fixative compositions and methods of the present invention. More specifically, FIG. 9 illustrates pancreatic acinar cells fixed using the 5% unbuffered zinc formalin fixative described above and stained with the hematoxylin and eosin stain. “Light” and “dark” differentially-stained cells are visible in the sample.

### Example 10

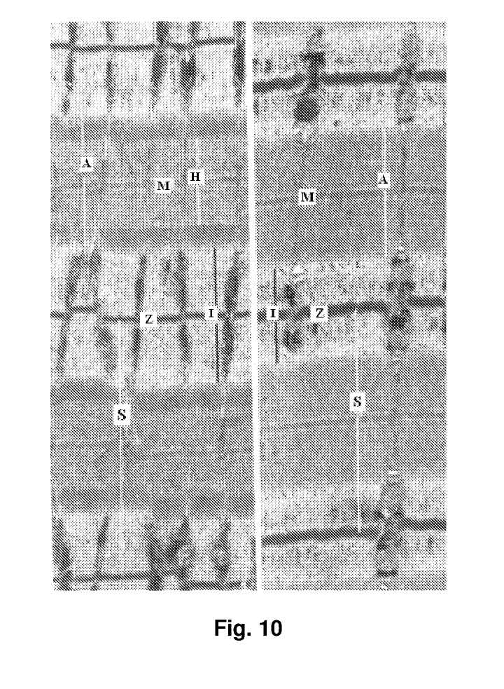

FIG. 10 is an electron micrograph of stretched and contracted skeletal muscle tissue. Principal features are identified by lettering as follows: sarcomere=S, A-band=A, I-band=I, H-band=H, M-line=M, and Z-line=Z. The H-band and I-band are wide in the stretched myofibrils shown in FIG. 10 on the left, while the H-band is absent and the I-band is narrow in the contracted myofibrils shown in FIG. 10 on the right. Although the two muscle specimens illustrated appear similar, the specimen on the left is from a rabbit, while the specimen on the right is from a human. FIG. 10 was obtained from Ultrastructural Pathology of the Cell and Matrix: A Text and Atlas of Physiological and Pathological Alterations in the Fine Structure of Cellular and Extracellular Components, Ghadially, Feroze N., 3d Ed., Vol. 2, Butterworths: Boston, pp. 842-843, 954-957.

### Example 11

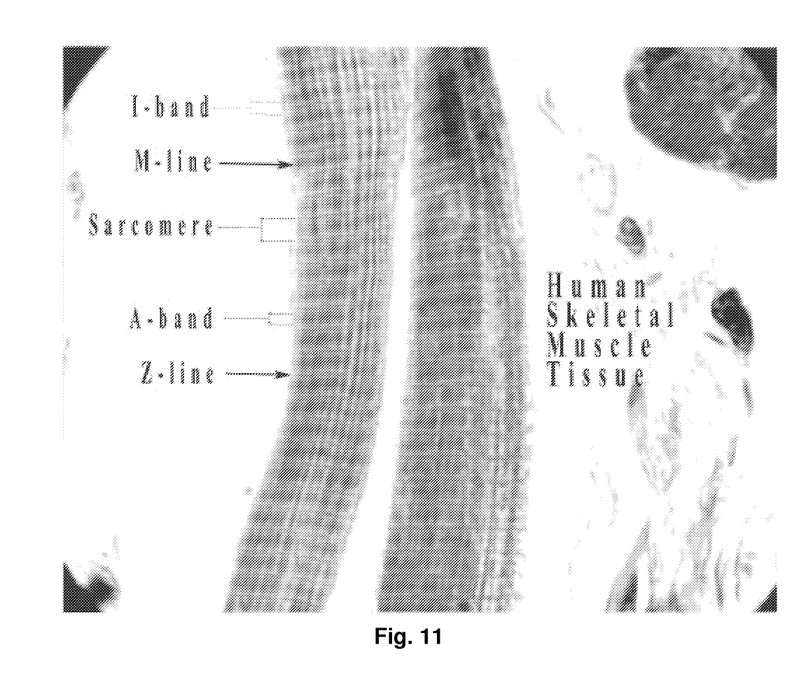

FIG. 11 is a light micrograph of a specimen of human skeletal muscle tissue prepared using the fixative compositions and methods of the present invention and stained with hematoxylin and eosin. The I-band, M-line, sarcomere, A-band, and Z-line are visible in this micrograph as in FIG. 10.

### Example 12

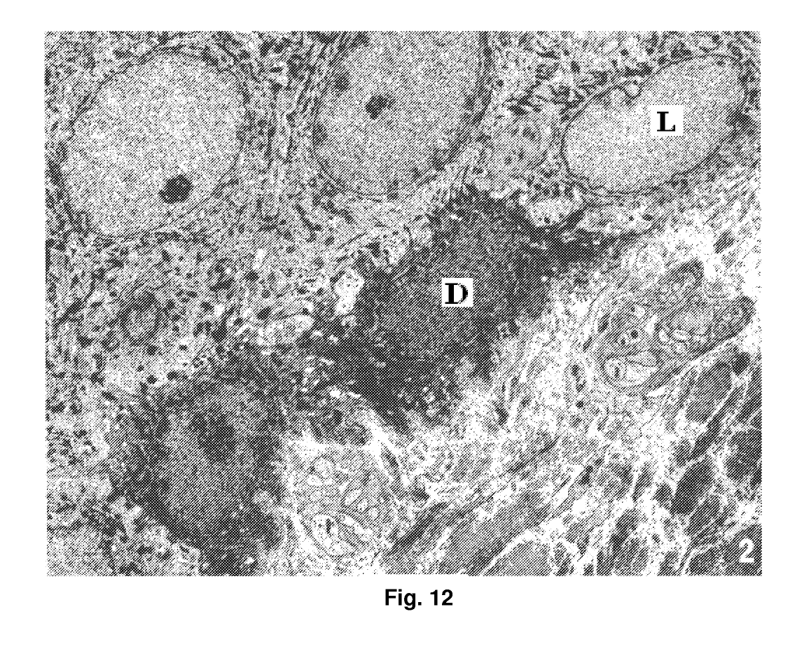

FIG. 12 is an electron micrograph of dark (D) and light (L) human cutaneous epithelial cells taken from a skin biopsy of a case of tuberous sclerosis. FIG. 12 was taken from Ultrastructural Pathology of the Cell and Matrix: A Text and Atlas of Physiological and Pathological Alterations in the Fine Structure of Cellular and Extracellular Components, Ghadially, Feroze N., 3d Ed., Vol. 2, Butterworths: Boston, pp. 842-843, 954-957.

### Example 13

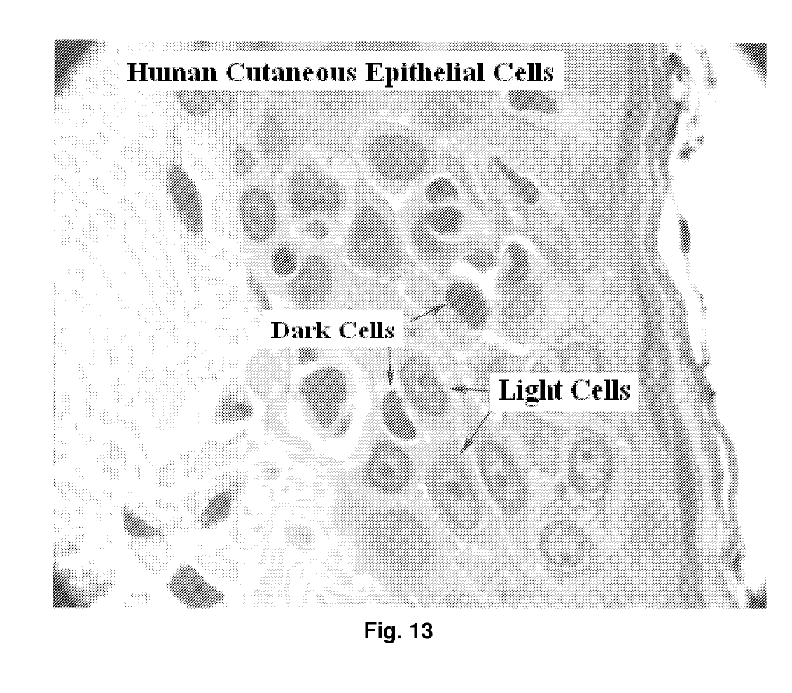

FIG. 13 is a light micrograph of a specimen of human cutaneous epithelial cells prepared using the fixative media and methods of the present invention. As with the previous examples prepared accordingly, the 5% unbuffered zinc formalin fixative medium was used and the tissue was stained with hematoxylin and eosin. This revealed differential staining of dark and light cells as indicated in FIG. 13.

Several benefits of the compositions and methods of the present invention include, but are not limited to, improved visualization of cellular and intracellular morphology and function, including evaluation of differentials in post-mitotic cell pairs; studies of differences in chromosomes during mitosis; diagnostic testing by improved identification of detailed histochemical and enzymatic features of cellular organelles such as mitochondria; evaluation of differential viral infections and improved cancer diagnosis and gradation. The detail provided by the present methods enables better morphologic characterization of lymphocyte subtypes in inflammatory and normal histologic conditions, and also improves the effectiveness of various therapies on malignant cells.

The methods and compositions of the present invention are also useful in areas such as embryology. More specifically, employing the methods and compositions of the present invention in a field such as embryology will allow the observation of detail at stages of embryogenesis and morphogenesis that have never before been possible. Further, these methods may be powerful tools in studies of differential proteomics and differential glycoproteomics and to explain the epigenetics of structural biology.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A method of preparing a tissue sample for microscopic examination, the method comprising the steps of:
obtaining a tissue sample;
fixing the tissue sample;
removing water from the sample by exposing it to a water replacement medium comprising an alcohol and at least 0.1% by weight water, wherein exposure to the water replacement medium results in the substantial removal of the free water in the sample, while allowing substantial retention of structural water; and
exposing the tissue sample to a space-replacement medium to displace the water-replacement medium, the space-replacement medium comprising an alcohol-miscible solvent.

2. The method of claim 1, wherein by the step of fixing the tissue sample includes exposing the sample to a first fixative medium comprising an aldehyde-based fixative medium with an osmolarity of from about 500 to about 1200 mosm/L.

3. The method of claim 2, wherein the first fixative medium comprises from about 4.5% to about 5% by weight formalin.

4. The method of claim 2, wherein the first fixative medium comprises 1.5% to about 2% by weight formaldehyde.

5. The method of claim 2, wherein the first fixative medium comprises from about 1.5% to about 2% by weight of paraformaldehyde.

6. The method of claim 1, wherein the water replacement medium comprises from about 0.1% to about 0.2% by weight water.

7. The method of claim 1, wherein the alcohol of the water replacement medium is ethanol.

8. A method of visualizing a stabilized tissue section comprising the steps of:
removing a stabilizing medium from the tissue section using a mixture of a stabilizing medium miscible solvent and greater than or equal to 0.1% by weight water;
exposing the tissue sample to a water replacement medium comprising an alcohol and greater than or equal to 0.1% by weight water;
applying a tissue stain; and
mounting the tissue section to a suitable viewing medium.

9. The method of claim 8, wherein the alcohol of the water replacement medium is ethanol.

10. The method of claim 9, wherein the water replacement medium comprises from about 0.1% to about 0.2% by weight water.

11. The method of claim 8, wherein the step of applying a tissue stain includes a step of applying a hematoxylin stain and/or an eosin stain.

12. A method of quantitatively judging the exactness of the detail obtained in a photomicrograph comprising the steps of:
obtaining a digital color photomicrograph of a stained sample using a light microscope at a magnification of from about 600× to about 1,000×;
inverting the colors of the color digital micrograph;
converting the color digital micrograph to grayscale; and
comparing the resulting photomicrograph with a corresponding electron micrograph.

13. A tissue fixative for fixing tissue in preparation for microscopic examination comprising an unbuffered solution having from about 1% to about 2% by weight of an aldehyde-based fixative with an osmolarity of less than about 1200 mosm/L.

14. The tissue fixative of claim 13, wherein the aldehyde-based fixative is selected from the group consisting of: formaldehyde, glutaraldehyde, and paraformaldehyde.

15. The tissue fixative solution of claim 14, wherein the aldehyde-based fixative comprises from about 4.5% to about 5% by weight formalin.

16. The method of claim 14, wherein the aldehyde-based fixative comprises about 1.6% to 1.8% by weight formaldehyde.

17. The method of claim 14, wherein the aldehyde-based fixative comprises from about 1.5% to about 2% by weight of paraformaldehyde.
